(19) United States
(12) Patent Application Publication
(10) Pub. No.: US 2005/0041564 A1
(43) Pub. Date: Feb. 24, 2005

(54) SOUND RECORDING APPARATUS FOR RECORDING AUDIO SIGNALS USING OPTICAL ACCESS TECHNOLOGY

(76) Inventors: Hsi-Yuan Hsu, Taipei City (TW); Chun-Hsien Lee, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,270

(22) Filed: Sep. 18, 2003

(30) Foreign Application Priority Data
Aug. 18, 2003 (TW) 092122664

(51) Int. Cl. G11B 7/00

(52) U.S. Cl. 369/124.05

(57) ABSTRACT

A recording apparatus includes a microphone for receiving sound waves and generating a corresponding audio signal, a signal module for providing corresponding sound data according to the audio signal, and an optical recording module for writing the data optically onto optical storage media. The optical recording module is only for writing the data optically into the optical storage media.

### BACKGROUND OF INVENTION

1. Field of the Invention

The present invention relates to a sound recording apparatus, and more specifically, to a sound recording apparatus that can record sound data onto optical storage media.

2. Description of the Prior Art

Hearing is an important sense of human beings, thus technology dealing with recording sound continues to develop with the goal of recording sound distortion-free. As electronic technology progresses, sound wave signals can be converted into electronic sound data, and the information industry continues to research various kinds of sound recording technology in order to preserve sound data with lower cost, lower distortion, and higher convenience.

Please refer to FIG. 1 showing a block diagram of a conventional recorder 10. The recorder includes a microphone 12, a magnetic recording module 14, and a driver 16 to record sound data on a tape 20 within a cassette 18, that is, to record sound data using magnetic media. The cassette 18 includes two spindles 22A and 22B, and the tape 20 winds around the two spindles and is contained in the cassette 18. The driver 16 of the recorder 10 rotates the spindles 22A and 22B to drive the tape 20 to scroll between the two spindles. The microphone 12 converts sound wave into an electronic audio signal 26, and the magnetic recording module 14 converts the audio signal 26 into corresponding sound data. The data is then magnetically recorded on the tape 20 scrolled by the driver 16 to preserve the sound data.

The prior art using magnetic media to record sound data has several disadvantages. First, magnetic sound data on the tape may distort due to interference by other magnetic materials. Furthermore, each time the tape is read, the distortion grows larger, which causes damage to the quality of the sound data. Additionally, the magnetism of the tape attracts moisture and dust so that the sound data is further distorted. When reading the tape, it is also required to expand the tape so that the life of the tape itself is shortened. The sound data recorded on the tape is an analog signal, which not only distorts but is also inconvenient to organize and index. For example, if a plurality of different sound data is recorded on the tape, the user can only guess an approximate location of a particular piece of the sound data, and play this part of the tape to ensure the guess is correct. If not, the process needs to be repeated again and again until the correct part of the tape is found. This is very inconvenient.

In addition to the tape recorder, recorders using a flash memory (also referred to as recording pens) also exist in the prior art, which records sound data in its build-in flash memory. One disadvantage of the recording pen is that the flash memory is expensive so that the cost is not easy to reduce even in large scale production. For recording pens, a flash memory of large size is required to record long-duration sound data. However, the flash memory is complicated in structure so that the cost is not easy to be reduced. Moreover, due to its structure and operation, the flash memory has a limited life span. Furthermore, when the user is going to play or transmit the sound data recorded in the flash memory, a computer system is required reducing the convenience of the recording pen. In modern technology, players of better sound quality (such as a CD player) cannot read and play the sound data in the flash memory. The user must download the sound data to a computer system and play the data using a player of the computer system. Similarly in the prior art, since the flash memory is built into the recording pen, if the user is going to transmit the sound data to others or if the volume of sound data exceeds the capacity of the flash memory, the user must download the sound data to a computer system. These disadvantages cause conventional recording pens to be inconvenient to use.

### SUMMARY OF INVENTION

It is therefore a primary objective of the present invention to provide a sound recording apparatus that can record sound data using optical storage media, in order to solve the problems in the prior art.

Briefly summarized, a recording apparatus includes a microphone for receiving sound waves and generating a corresponding audio signal, a signal module for providing corresponding sound data according to the audio signal, and an optical recording module for writing the data optically onto optical storage media. The optical recording module is only for writing the data optically into the optical storage media.

The recording apparatus (hereinafter referred to as the recorder) converts sound waves into an electronic audio signal using the microphone, and further into a digital audio signal using a digital-to-analog converter (DAC). After the signal module converts the digital audio signal into sound data, the optical recording module can write the sound data optically onto the optical storage media. In the preferred embodiment of the present invention, the optical storage media is a CD-R/RW optical disk. Since high quality players can read and play sound data on optical disks, the sound data can be easily played, transmitted, and shared. Moreover, optical disks have low cost and large capacity. Optical disks preserve the data well, are not easily interfered by moisture and dust, and have longer life than conventional tapes. Furthermore, digital sound data is more easily searched, and the cost of the optical recording modules is reduced. In other words, the recorder according to the present invention provide a better means to preserve sound data with low cost, low distortion, and high convenience.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional recorder.

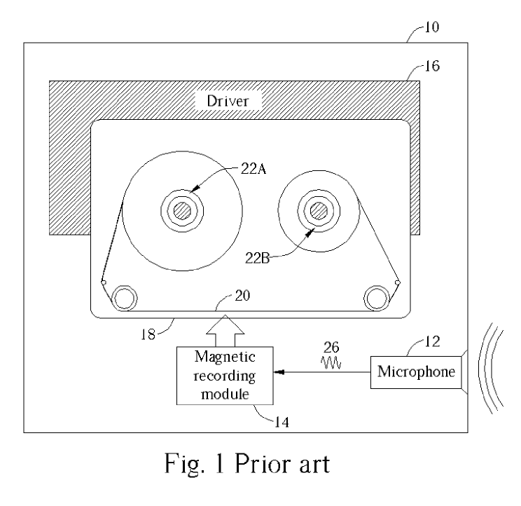

FIG. 2 is a block diagram of a recording apparatus according to the present invention.

FIG. 3 is a block diagram of a recording apparatus according to the second embodiment of the present invention.

### DETAILED DESCRIPTION

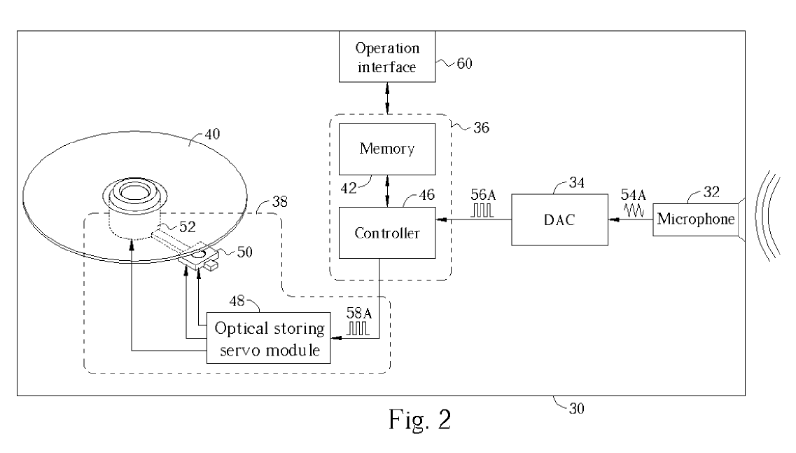

Please refer to FIG. 2 showing a block diagram of a recording apparatus 30 according to the present invention. The recording apparatus 30 (hereinafter referred to as the recorder 30) includes a microphone 32, an analog-to-digital converter (ADC) 34, a signal module 36, an operation interface 60, and an optical recording module 38 for writing sound data optically onto an optical disk 40 being used as optical storage media. The microphone 32 is for converting sound waves into an analog electronic audio signal 54A, the ADC 34 converts the analog audio signal 54A into a digital audio signal 56A. The signal module 36 includes a controller 46 and a volatile memory 42 (such as DRAM). The controller 46 is for controlling the operation of the recorder 30 and encoding and modulating the audio signal 56A (or filtering noises) to form corresponding sound data 58A. The memory 42 is for temporarily storing data necessary for the controller 46. The operation interface 60 includes buttons and/or a screen and indicating lights. The user can input commands using the buttons, and the buttons transmit the commands to the signal module 36. The controller 45 processes the commands and transmits the result to the operation interface 60 to show the result using the screen or the indicating lights. As shown in FIG. 2, the optical recording module 38 includes an optical storing servo module 48, a pickup head 50, and a motor 52. The motor 52 rotates the optical disk 40, the pickup head 50 generates a laser beam toward the optical disk 40, and the optical servo module 48 controls the rotational speed of the motor 52 and the movement of the pickup head 50 to generate the laser at the proper power, in order to write the sound data 58A generated by the signal module 36 optically onto the optical disk 40.

In the preferred embodiment of the present invention, the optical disk 40 complies with the CD-R/RW standard. Because the CD-R/RW standard is widely recognized in the industry, the sound data recorded on the optical disk 40 can be played by high quality players (such as a CD players). In other words, the user can remove the optical disk 40 from the recorder 30 to play without requiring a computer system. In addition, the optical disk costs less while have large capacity, and the cost on the optical recording module is reduced, so that the recorder according to the present invention is inexpensive. Moreover, the optical disk is thin and compact, and has a longer life than conventional tapes without interference by dust and moisture. The sound data recorded by the optical disk can therefore be preserved for a longer time. In the recorder 30 according to the present invention, the sound data is written digitally onto the optical disk 40, so that when the signal module 36 generates the sound data 58A, relating data (such as date of recording or a label input by the user through the operation interface 60) can be attached to the sound data 58A and written onto the optical disk 40. When searching and accessing specific sound data on the optical disk 40, the user can index the required sound data according to the attached data label, which is very convenient.

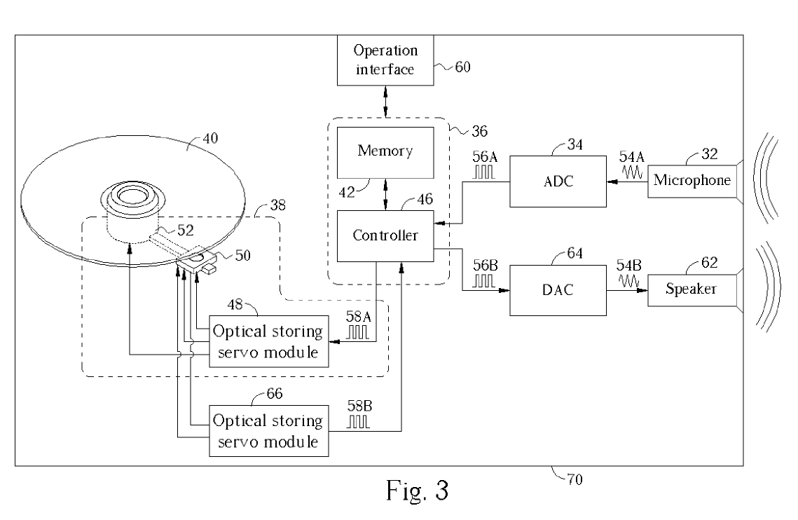

Of course, a playing function can also be added to the recorder according to the present invention in order to play the sound data on the optical storage media. Please refer to FIG. 3 showing a block diagram of a recording apparatus 70 according to the second embodiment of the present invention. Besides the microphone 32, the ADC 34, the signal module 36, and the optical recording module 38, which are the same to the recorder 30 in the first embodiment, the recording apparatus 70 (hereinafter referred to as the recorder 70) further includes an optical reading servo module 66, a digital-to-analog converter (DAC) 64, and a speaker 62, for reading and playing sound data recorded on the optical disk 40. The optical reading servo module 66 can use the same pickup head 50 and motor 52 as the optical storing servo module 48 to implement optical reading, harmonize the operation of the motor 52 and the pickup head 50, control the pickup head 50 to generate a proper laser, analyze sound data 58B from the optical disk 40 to the pickup head 50, and transmit the result to the signal module 36. The controller 46 in the signal module 36 decodes the sound data 58B to generate a corresponding digital audio signal 56B, and analyzes data attached to the sound data 58B if attached data exist. The attached data can be displayed by the operation interface 60 or temporarily stored in a memory 42 for further usage (such as searching). The digital audio signal 56B is converted into an analog audio signal 54B by the DAC 64 so that the speaker 62 can play the audio signal 54B. Besides installing the speaker 62 in the recorder 70, an audio signal output port can be installed in the recorder 70 for outputting the audio signal 54B. In this case, the user can connect a speaker or headphones to the output port to hear the sound data. In the recorder 70 and recorder 30, the optical storing servo module 48 and the optical reading servo module 66 can be implemented by a hardware circuit or firmware executed by the controller 46.

In contrast to the tape recorder and the recording pen according to the prior art, the recording apparatus according the present invention has many advantages including a longer life than conventional tapes, lower cost, convenience of arranging and searching the digitally recorded sound data, as well as low distortion, high quality, and long endurance.

Those skilled in the art will readily observe that numerous modifications and alterations of the device may be made while retaining the teachings of the invention. Accordingly, the above disclosure should be construed as limited only by the metes and bounds of the appended claims.

1. A recording apparatus comprising:
a microphone for receiving sound waves and generating a corresponding audio signal;
a signal module for providing corresponding sound data according to the audio signal; and
an optical recording module for writing the data optically onto optical storage media, wherein the optical recording module is only for writing the sound data optically onto the optical storage media.

2. The recording apparatus of claim 1 further comprising:
a digital-to-analog converter (DAC) electrically connected between the microphone and the signal module, for converting the audio signal generated by the microphone into a digital audio signal, wherein the signal module provides the sound data according to the digital audio signal.

3. The recording apparatus of claim 1 wherein the optical storage media is an optical disk.

4. The recording apparatus of claim 3 wherein the optical recording module comprises:
a motor for rotating the optical disk; and
a pickup head for generating a corresponding laser onto the optical disk according to the sound data, in order to write the sound data onto the optical disk.

5. The recording apparatus of claim 1 further comprising an optical reading module for reading data from the optical storage media and generating corresponding second sound data.

6. The recording apparatus of claim 5, wherein the signal module provides a corresponding second audio signal according to the second sound data, and the recording apparatus further comprises:
a speaker for converting the second audio signal into corresponding sound waves.

7. The recording apparatus of claim 6 further comprising:
a DAC electrically connected between the signal module and the speaker, for converting the second audio signal into an analog second audio signal, wherein the speaker is for converting the second audio signal into corresponding sound waves.
